(19) United States
(12) Patent Application Publication
(10) Pub. No.: US 2005/0236544 A1
(43) Pub. Date: Oct. 27, 2005

(54) Cable organization and hardware shelving system

(75) Inventors: John G Mancino, Boulder, CO (US); Robert K. Bellows, Boulder, CO (US)

Correspondence Address: TIMOTHY J MARTIN, PC, 9250 W 5TH AVENUE, SUITE 200, LAKEWOOD, CO, 80226, US

(73) Assignee: Device Works Company

(21) Appl. No.: 10/521,692

(22) PCT Filed: Jun. 6, 2003
(86) PCT No.: PCT/US03/18091

§ 371 Date: May 13, 2005

Related U.S. Application Data
(60) Provisional application No. 60/396,964, filed on Jul. 17, 2002.

(51) Int. Cl. F16B 45/00

(52) U.S. Cl. 248/304

(57) ABSTRACT

A mounting bracket is used in a system for supporting electrical components to a support structure. The mounting bracket includes a base with an elongate beam that having a planar web and at least one transverse flange and a hook structure that may be an elongate arm. The mounting bracket has various structures to secure wires, auxiliary suspension members, cable ties and the like. The system utilizes two brackets that together form a shelf to support electronic equipment. The brackets may mount on a slotwall-type upright support member or,

[symbol]

### CROSS-REFERENCE TO RELATED APPLICATIONS

This application claims the benefit of U.S. Provisional Application No. 60/396,964 filed Jul. 17, 2002.

### FIELD OF THE INVENTION

The present invention relates to user configurable systems for supporting hardware. More specifically the present invention concerns a system for supporting and organizing electronic equipment and cables incorporating mounting brackets and upright support members.

### BACKGROUND OF THE INVENTION

A typical home entertainment system, computer system or other pieces of office equipment typically have a plethora of cables and hardware components associated with them. Hardware items such as external hard drives, network routers, power supplies, and modems need to be connected to the computer, or other electronic system, but usually do not need to be directly accessible for routine use. Cables can become tangled and create a clutter that makes configuration changes and cleaning more difficult than it needs to be. Loose cables lying on the floor can also be a safety and fire hazard. While there are several devices available for grouping and binding cables, e.g. cable clamps, nylon ties, and wire ties, as well as devices for guiding and hiding cables, e.g. spiral channels and cable clips, there are no approaches which address all of the problems of organizing hardware and cables.

### SUMMARY OF THE INVENTION

Therefore, it is the object of the present invention to provide a new and useful system and method for organizing and storing electronic hardware and cabling.

Another object of the present invention to provide a system which can be easily arranged for configuring the equipment placement and cable routing as well as reconfiguring the system when changes are to be made.

It is another object of this invention to provide new and useful mounting brackets and upright support members such that the brackets can be configured on an upright member to create shelving for hardware devices.

A further object of the present invention is to provide a support system with numerous openings and connection points to facilitate the suspension and support of cabling.

Yet another object of the present invention is to provide a system, a method and components for organizing the complex wiring for computers, stereo systems, audio/video components and the like so as to reduce the tangle and clutter of the various wires, cables and interconnects.

Still a further object of the present invention is to reduce safety and fire hazards attendant to disorganized wires and cables.

According to the present invention, then, a support system is provided that is adapted to support electrical components and wires therefore relative to a structure. Broadly, the system includes a first upright support member adapted to be secured in a generally vertical orientation relative to support structure to define a secured state. At least two mounting brackets are provided in this system with each mounting bracket including a base portion adapted to engage the upright support member, a generally rigid elongate beam extending forwardly to the base portion and an elongate support arm extending forwardly to the base portion.

More particularly, the present invention is also directed to a new and useful mounting bracket for use with the support system. The mounting bracket is adapted to secure to an upright support member when in a secured state. The mounting bracket includes a base having a front and back, and the base is operative to engage the upright support member in a secured state. An elongate beam extends forward of the base portion to terminate in a free beam end. The beam includes a planar web oriented in a web plane. The planar web has a selected web length between the base and the free beam end, a selected web height between an upper and a lower edge thereof and a selected web thickness. The beam also includes a first flange oriented transversely to the web and having a first flange width that is greater than the web thickness but less than the web height. The elongate beam also includes a hook structure extending forward of the base portion and supported thereby. This hook structure may be in the form of an elongate support arm that terminates in a free arm end with the support arm being in spaced relation to the beam.

The base includes an upper inverted J-shaped mounting portion disposed thereon and may further include a latch structure to help secure the base to the upright support member. The planar web includes at least one opening formed therein, but is desirable that a plurality of openings be formed in the planar web. At least one of these openings is formed as a slot that is adapted to pinch connect an elastic cord. The planar web also has a forward edge, and a slot opening that may be formed in the forward edge with the slot intersecting the forward edge. A reinforcement rib extends along the forward edge proximately thereto. A rearward reinforcement rib may also be located proximate to the base.

The first flange, in the disclosed embodiments, is located on the upper edge of the planar web and extends forwardly for first flange length. The beam can also include a second flange disposed on the lower edge of the planar web with the second flange extending forwardly for a second flange length. The second flange has a second flange width that is less than the first flange width but that is greater than the web thickness. Moreover, the second flange length is shown to be less than the length of the first flange. The second flange can also have forwardly convergent opposite side edges.

As noted, the hook structure may be an elongated arm spaced apart from the beam portion that terminates in a free arm end with this free arm end extending forwardly of the planar web. The elongated arm generally lies within the web plane. A pad is formed on the free arm end with this pad including a lip that extends rearwardly toward the base. A gusset extends between the elongated arm and the beam portion to rigidify the support arm. The elongated arm terminates in an arcuate free arm end which curves toward the beam portion to leave a gap between the planar web and the free arm end.

As noted above, this mounting bracket forms part of a support system adapted to support electrical components and wires therefore. Here, the first upright support member is adapted to be secured in a generally vertical orientation relative to a support surface to define the secured state. The first upright support member includes at least two support panel sections each having an exposed and free upper edge when in the secured state. At least two mounting brackets, such as the type described above, are provided. The mounting brackets according to the system include at least a base having a front and back adapted to engage the upper edge of respective support panel section in a mounted state whereby at least two mounting brackets may be simultaneously supported in the mounted state. Each bracket also includes a generally rigid elongate beam extending forwardly of the base and an elongate support arm also extending forwardly of the base. The beam has an upper surface that is generally horizontal when the support member is in the secured state and with the bracket in the mounted state. The beam of each mounting bracket has a vertically extending web that defines a web plane. The elongate support arm is then generally in the web plane and terminates in a free arm end.

The support system can also include a plurality of suspension members adapted to receive and releasably retain wires associated with the electrical components. The suspension members may be defined by a plurality of cable hangers each adapted to engage the support arm of one of the mounting brackets. Each of these cable hangers may have a flat body with a hook structure adapted to engage the support arm of one of the mounting brackets, a locking tab, and an elongated flexible tail. The tail is connected at a proximal end to the flat body and has a free end selectively engagable by the locking tab.

The first upright support member can have a plurality of slots formed therein, and the system includes at least one elastic cord releasably mountable in the slots. Each of the mounting brackets can also include at least one slot formed therein, and an elastic cord may be releasably mounted in these slots, as well. In the system, also, either one or both of the mounting brackets in the upright support members has a plurality of holes formed therein and includes a cable connector adapted to mateably mount in the hole.

The support system can also include a second upright support member that is different from the first upright support member. Here, one of the first and second upright support members is operative to selectively mount another of the first and second upright support members.

In a more expanded version, the support system according to the present invention includes first and second upright support members. The first upright support member includes at least two capture flanges, and the second upright support member includes at least two opposing tabs adapted to secure to the capture flanges and includes at least two support panel sections each having a exposed edge. This expanded system also includes at least two mounting brackets. Here, each mounting bracket includes a base adapted to engage the exposed edge of a respective support panel section in a secured state whereby the mounting brackets may be simultaneously supported in the secured state. Each mounting bracket also includes an elongated support arm including a central portion extending forwardly of the base and terminating in a free first arm end. The mounting bracket also has an elongate beam extending forwardly of the base in spaced apart relation to the support arm.

The present invention is also directed to a method for organizing and storing electronic equipment and cabling comprising the steps inherent in the above-described structure. More particularly, the method includes a step of releasably attaching at least one support member to a support surface such that a support member is oriented in an upright state. The method also includes the step of selectively arranging a plurality of mounting brackets onto the mounting member in a manner to create an array defining a stable, generally horizontal support surface for equipment. The method then includes the step of releasably locking the mounting brackets to the support member. Finally, the method includes placing electronic equipment on the mounting brackets and securing electric cables by suspending them from the mounting brackets.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a perspective view of an upright panel with attached brackets and with a hardware device and cables according to one embodiment of this invention;

FIG. 2 is a perspective view of the panel with attached brackets of FIG. 1 without the hardware device and cables;

FIG. 3 is a perspective view of a post with attached brackets according to another embodiment of the present invention;

FIG. 4 is a perspective view of the upright panel of FIGS. 1 and 2;

FIG. 5. is a cross sectional view of the panel shown in FIG. 4 taken about lines 5-5;

FIG. 6 is a top view in elevation of the panel shown in FIG. 4;

FIG. 7 is a perspective of a slatwall according to the prior art;

FIG. 8 is a frontal perspective view of the mounting post of FIG. 3 with inserted clamp head;

FIG. 9 is a rearward perspective view of the mounting post shown in FIG. 8;

FIG. 10 is an exploded view in perspective of the mounting post shown in FIGS. 8 and 9;

FIG. 11 is sectional side view of the mounting post shown in FIGS. 8 through 10 taken about lines 11-11 of FIG. 8;

FIG. 12. is a sectional side view of the mounting post shown in FIGS. 8 through 10 taken about lines 12-12 of FIG. 8 and where the latch is shown in phantom in the open position;

FIG. 13 is a perspective view of the post of FIGS. 8-10 shown with the panel and brackets of FIG. 2 attached thereto;

FIG. 14 is a sectional side view of a table/desk top with a grommet and with the mounting post of FIGS. 8-10 secured thereto;

FIG. 15 is an oblique side view of a second embodiment of a mounting post including a locking grommet

FIG. 16 is a sectional side view of the second embodiment of the mounting post with an inserted locking grommet;

FIG. 17 is a perspective view of a plate, the edge of a desk, and the upper portion of a second post embodiment;

FIG. 18 is a side view in elevation of a mounting bracket according to a first embodiment of the present invention;

FIG. 19 is a cross sectional view of the bracket shown in FIG. 18 taken about lines 19-19 thereof;

FIG. 20 is a perspective view of the forward end of the beam portion of the bracket shown in FIG. 18;

FIG. 21 is side view in elevation of a second embodiment of the mounting bracket depicted as attached to a slatwall;

FIG. 22 is a perspective view of the forward end of the bracket shown in FIG. 21;

FIG. 23 is a perspective view of a first side of a cable hanger used in the system according to the present invention and shown in an open position;

FIG. 24 is a perspective view of the opposite side of the cable hanger shown in FIG. 23 shown in an open position;

FIG. 25 is a perspective view of the cable hanger shown in the closed position;

FIG. 26 is perspective view of a cable connector known in the prior art and used in the system according to the present invention;

FIG. 27 is a perspective view of another embodiment of a cable connector known in the prior art and used in the system according to the present invention; and

FIG. 28 is a perspective view of the first embodiment of the post with a pair of attached mounting panels and mounting brackets therefor.

### DETAILED DESCRIPTION OF THE EXEMPLARY EMBODIMENTS

The present invention is directed to a system for organizing and storing electronic hardware and cabling. The present invention is also directed towards a system and method which can be easily arranged for configuring the equipment placement and cable routing as well as reconfiguring the system when changes are to be made.

According to the present invention, the cable storage and hardware shelving system broadly includes: upright members either in the form of posts for mounting to office furniture, shelves or other horizontal surfaces or in the form of panels or slatwalls for mounting to posts, walls or other upright surfaces; mounting brackets which are releasably attachable to either the posts, panels or slatwalls; and cable hangers or commercially available cable attachment devices. The mounting brackets can be arranged on the panels or slatwalls to create horizontal shelf surfaces for supporting hardware items such as hard drives, routers, powers supplies, modems, etc. The panels and slatwalls can be mounted to vertical surfaces or can be attached to the posts. The mounting brackets have support arms for the convenient suspending and organizing of cables and cable bundles. The panels, posts and mounting brackets also have numerous openings that accept a variety of cable connectors to facilitate the cable support and routing.

The panels, posts, slatwalls, and brackets are releasably attached to one another, making it easy to arrange the system's configuration before mounting or attaching the hardware and cabling. No tools are necessary for assembly of a system except when one wishes to fasten a post to a surface with screws, bolts, or other fasteners.

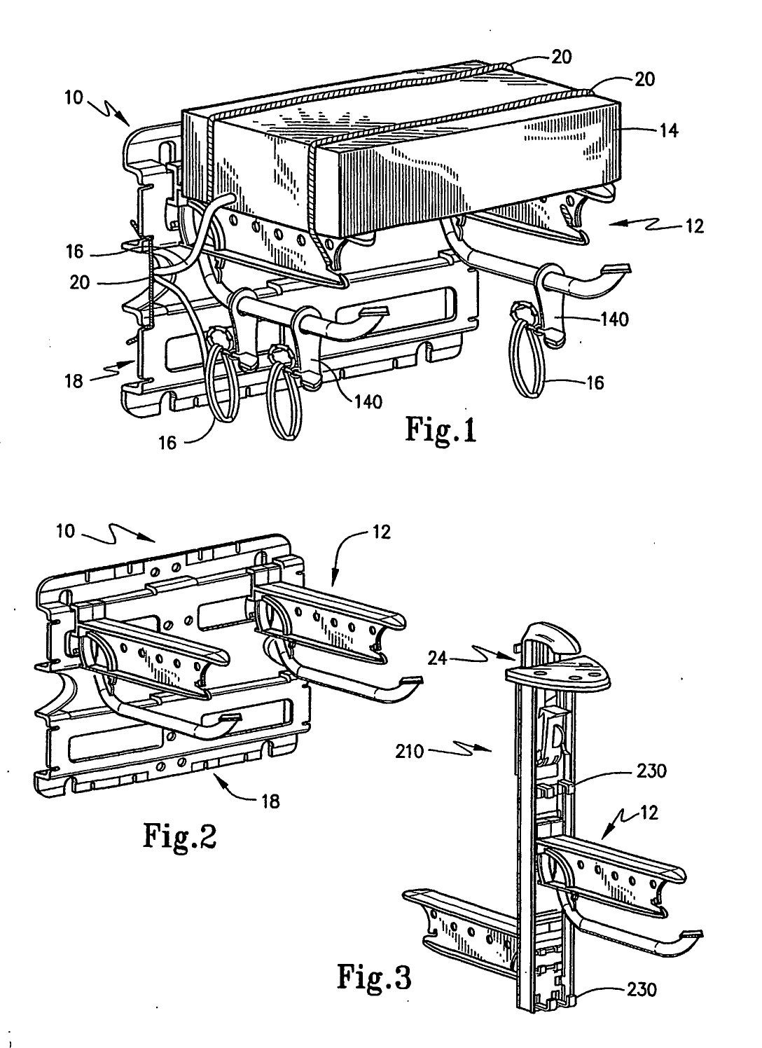

To understand the various uses and configurations of the invention, reference is first made to FIGS. 1 through 3 and FIG. 13. FIG. 1 shows a perspective of one possible configuration 10 consisting of an upright member in the form of a panel 18 with attached mounting brackets 12 supporting a representative hardware device 14 and cables 16 attached to the system 10 for illustrative purposes. FIG. 2 shows the same system configuration 10 as in FIG. 1 but without any equipment supported thereby. In FIG. 1 the hardware device 14, for example a modem or hard drive, rests on a pair of brackets 12 which have been attached to panel 18 to create a stable shelf for the device 14. The device 14 is retained by elastic cords 20. Cables 16 are suspended from the system 10 by cable hangers 140 which are, in turn, suspended from mounting brackets 12. Cables 16 are also mounted onto the panel 16 by elastic cords 20 attached to panel 18. FIG. 3 shows another system configuration 24 consisting of an upright member in the form of a post 210 with attached mounting brackets 12. Yet another system configuration is shown in FIG. 13 where a panel and bracket group (as in FIGS. 1 and 2) is attached to a post 210.

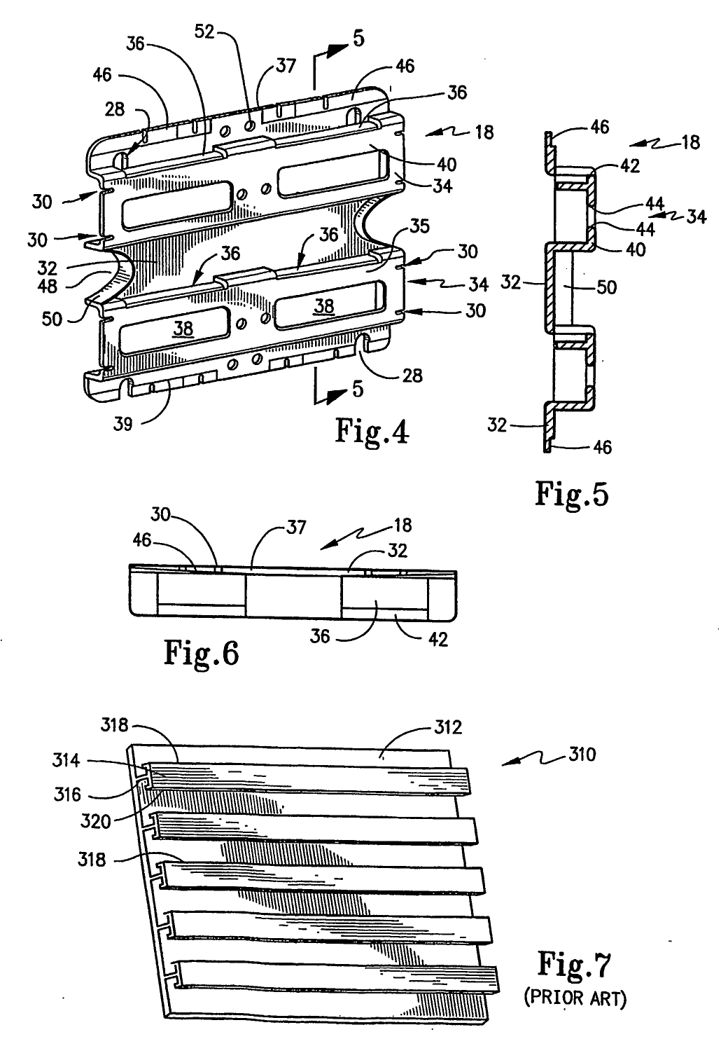

One embodiment of an upright support member, namely panel 18, is shown in more detail in FIGS. 4 through 6. As seen in FIG. 4, the panel 18 contains mounting slots 28 to facilitate attachment of the panel 18 to a flat surface by means of screws or bolts. The perimeter of panel 18 also has numerous cord slots 30 formed into it for the attachment of elastic cords 20, via a pinching connection, to aid in restraining cables and equipment. FIG. 1 shows an example of the use of elastic cords 20 for such restraint. The panel 18, as shown in FIG. 4, is formed of a planar panel 32 with two bracket mount portions 34 which are configured with openings 36 and 38 for supporting the mounting brackets 12. To facilitate this, each bracket mount portion 34 is formed of a planar panel 35 which is parallel to and forward of the panel 32 and which contains top openings 36, center openings 38, and a front face 40.

Referring to FIG. 5, a sectional side view of panel 18, the top opening 36 creates the upper edge 42 of panel 35 upon which a bracket can be suspended, as described below. Likewise, the center opening 38 creates center edges 44 and 44′ which are also employed to support a bracket 12. This may be better seen by referring to FIG. 2 which shows a bracket 12 attached to the bracket mount portion 34. The face 40 of the bracket mount portion 34 is spaced sufficiently far away from the panel surface 32 to leave sufficient room for the mounting bracket 12 to be attached without interfering with the mounting of the panel 18 to a surface or to a post 210.

As best seen in FIGS. 4 and 6, the upper and lower edges 37 and 39 of panel 18 have tapered edges 46. Looking at FIG. 6, the top view of a panel 18, these taper from a thin thickness at the transverse edges of the panel 18 to a thicker width near the center of the panel 18. This feature is present to facilitate the attachment of a panel 18 to a post 210. Referring to FIG. 13, which shows a system configuration of this mounting, the panel is captured by panel mount flanges 230 along its two tapered edges. The panel mount flanges 230 are sized such that when the panel is in the attached position (as shown in FIG. 13) there is a tight fit. The panel 18 is attached to the post 210 by inserting the leading edges of one side of the panel 18 into the gap between the flange and post and then sliding the panel towards the post 210 until the center portion of the panel edge is contacting the panel mount flanges 230. The taper of the panel edge makes it easier to first insert the panel 18 onto the post 210 and to slide it towards its final attached position via the thicker portions of the edges 37 and 39.

The panel 18 also possesses oval shaped indents 48 that serve as openings for cable routing from the front to the back of the panel 18. FIG. 1 shows an example of cables passing through this opening and being restrained in them by elastic cords 20. The curved panel edges that define these indents 48 are formed of indent ridges 50 whose thickness is greater than that of the panel surface 32. These ridges 50 add flexural stiffness to the panel 18. Finally, the panel 18 also contains numerous connection holes 52 which are sized to allow the use of commercially available cable connectors such as the types shown in FIGS. 26 and 27. One skilled in the art can see that the panel 18 can be sized to allow for any number of bracket mount portions 34 and also any number of openings 36.

Another embodiment of a panel is a prior art slatwall 310 shown in FIG. 7. This form of a panel consists of a back panel 312 with a multitude of mounting strips 314 offset from the back panel 312 by means of ribs 316. The strips 314 have upper and lower edges (318 and 320 respectively) which provide similar attachment locations as the edges 42 and 44 (respectively) found on the panel 18 (see FIGS. 4 and 5). The spacing and size of the mounting strips 314, ribs 316, and edges 318 and 320 is such that the bracket 12 can be attached without interference of the back panel 312.

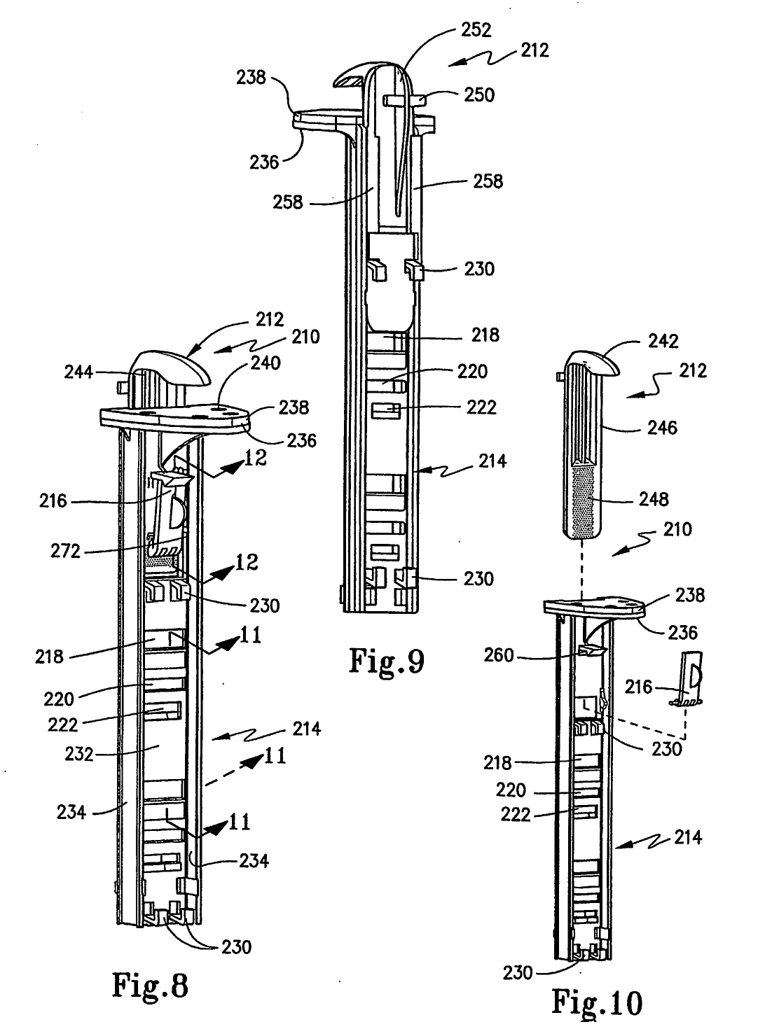

Another embodiment of an upright support member is the post 210, shown in FIGS. 8 through 10 and as part of a system in FIGS. 3 and 13. The post 210 provides a means of supporting panels (such as 18 and 310) and mounting brackets 12, with a horizontal surface such as a desk or shelf. The post 210 is an assembly consisting of four parts; the post body 214, the resilient pad 238, the clamp head 212, and the clamp arm 216.

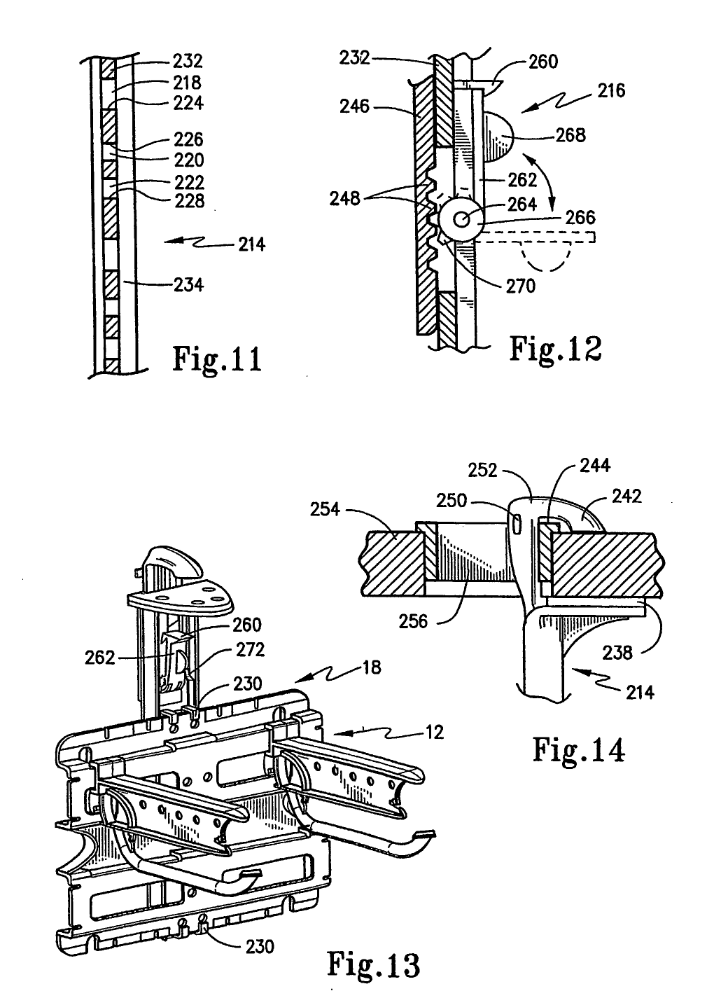

The post body 214 is made up of a rectangular post center panel 232 with transversely-oriented, parallel rectangular edge ribs 234 situated along the longitudinal edges of the center panel 232 to provide stiffness and strength to the unit. The center panel possesses upper, center, and lower openings (218, 220, and 222 respectively) which provide attachment locations for supporting as many as two brackets 12 (as illustrated in FIG. 3). FIG. 11 shows a sectional view of the post body 214 including these openings 218, 220, and 222 and is best for explaining these attachment locations. The configuration of the openings 218, 220, and 222 provides attachment edges similar to the openings and edges discussed previously for attachment of a bracket 12 to panel 18 or slatwall 310. The upper opening 218 exposes an upper edge 224 which, for the purposes of attaching a bracket 12, serves the same purpose as the upper edge 42 in FIG. 5. Likewise, the center opening 220 (FIG. 11) exposes a center edge 226 which serves the same purpose as the center edge 44 in FIG. 5. Finally, lower opening 222 exposes a lower edge 228 which serves the same function as the lower edge of the two center edges 44 in opening 38 of bracket 12 shown in FIGS. 4 and 5. The sizing of these openings and their locations are such that a bracket 12 will releasably attach to the post body 214.

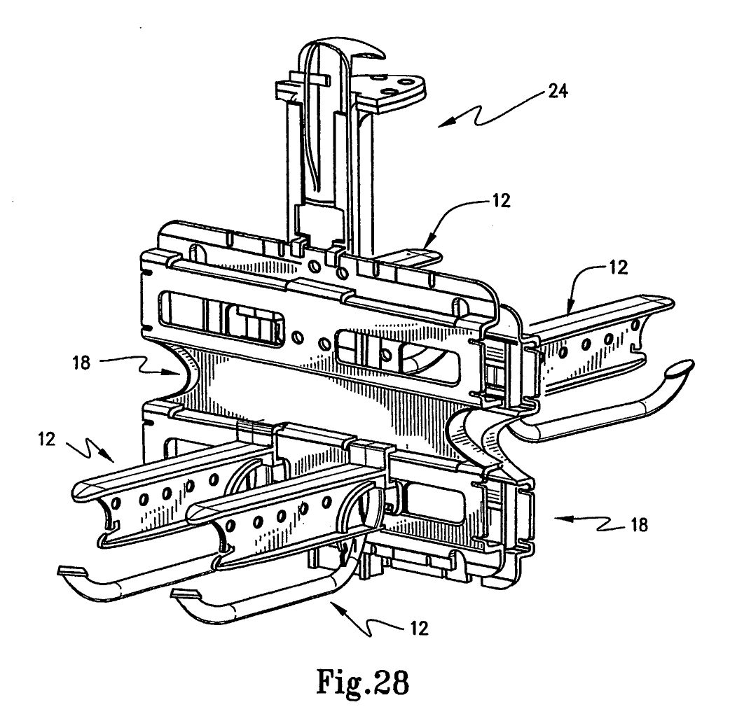

As seen in FIGS. 13 and 28, the post 210 also facilitates the support of upright members in the form of panels such as panel 12 shown in FIG. 4 or the slatwall 310 shown in FIG. 7. Referring to FIGS. 8 through 10, the post body 214 has L-shaped panel mounting flanges 230 disposed at the upper and lower ends of the post body 214 which are sized to produce slots for holding the upper and lower edges of the chosen panel insert. At both ends of post body 214 a pair of flanges 230 are affixed to the center panel 232 adjacent to each of the two post edges 234 and are aligned to present a horizontal channel for engaging the mounting edges of a panel 12 or slatwall 310. The flanges 230 are sized to produce a friction fit with the selected panels. Other embodiments of securing a panel into the flanges could include placing indents (or detents) on the inner edge of flanges 230 to coincide with detents (or indents, respectively) on the panel edges, thereby locking the panel into its final position.

The mounting end of the post body 214 has a rigidly attached flat, mounting flange 236, situated at a generally perpendicular angle to the longitudinal axis of the post body 214, for the mounting of the post body 214 to flat, horizontal surfaces. Affixed to the upper surface of this mounting flange 236 (i.e. the surface to be proximate to the desk or shelf surface) is a resilient pad 238 which is constructed of a resilient material. The mounting flange 236 and resilient pad 238 have several holes in them to facilitate the anchoring of the post body 214 to a surface with screws, nails, or bolts.

Aside from directly fastening the flange 236 to a surface, the post unit 210 can also be attached by clamping the post body 214 to a surface via the clamp head 212. This part can be seen in various views in FIGS. 8, 9, 10, 13 and 14. The clamp head 212 is made up of a clamp tongue 246, a clamp flange 242, a clamp rib 252, and cable tabs 250. The clamp tongue 246 is an elongated rectangular shaft whose longitudinal edges engage with tongue rails 258 located on the side of the post body 214 that is opposite to the side possessing the mounting flange 236. FIG. 9 shows the clamp head 212 inserted into the rails 258 of the post body 214 and FIG. 10 shows an exploded view of the post 210 with the insertion direction of the clamp head 212. The clamp head 212 slides freely within the rails 258 to provide for clamping adjustment. The forward surface of the clamp tongue 246 has several rows of locking teeth 248 which engage the mating teeth of the clamp arm 216 located on the post body 214 when the clamp head 212 is locked into position. The clamp flange 242 projects perpendicularly from the clamp tongue 246 providing a clamping surface opposing the clamping surface of the mounting flange 236.

To further illustrate the use of the clamp head, FIG. 14 shows a sectional side view of a typical desk or table top 254 including a cable hole and inserted grommet 256 with an attached post 210. The hole and grommet arrangement is commonly used in desk and table tops to channel cables between the upper and lower surfaces. The post 210 is mounted such that the clamp head 212 extends through the grommet's interior and grips the upper surface of the desk while the mounting flange 236 and resilient pad 238 complete the clamping action by gripping the lower surface. The resilient pad 238 provides an elastic compressive force on the surface to prevent the clamp from loosening should the post 210 or attached equipment be jostled. It should be noticed in FIG. 14 that the clamp flange 242 has a formed cavity 244 which is sized to provide clearance for the upper edge of the grommet 256 which protrudes above the desk surface.

The side of the clamp head 212 opposite of the clamp flange 242 has a rib 252 upon which are cable tabs 250. The tabs 250 can be used as cable guides or perches. When feeding cable upwardly through the hole (with the post 210 installed) one can temporarily catch the cable end or a cable loop onto these tabs 250 and then continue routing the cable from the top surface.

The clamp head 212 is adjusted and locked by way of a clamp arm 216 and arm latch 260 that is illustrated in FIGS. 10, 12 and 13. The clamp arm 216 consists of a rectangular lever 262 attached to a cylindrical shaft 266 which possesses shaft teeth 270. The lever 262 has a lever tab 268 for grasping when actuating the lever 262. The shaft 266 is held into place on the post body 214 by way of cylindrical pins 264 protruding from opposite ends of the shaft 266 which lock into shaft tabs 272 attached to the post body 214. In this manner, the shaft 266 has a free range of rotation. This range of rotation is demonstrated in FIG. 12 where the latch arm 262 is shown upright in the locked position and in phantom in the unlocked position. When in the unlocked position, the clamp tongue 246 is free to slide along the axis of the post body 214 and when in the locked position the tongue 246 is prevented from moving. This feature is accomplished by way of the mating of the locking teeth 248 with the shaft teeth 270. As seen in FIG. 12, a pair of shaft teeth 270 are positioned on the shaft 266 such that when the lever 262 is in the unlocked position the teeth 270 do not interfere with the tongue 246 movement. Also, when positioning the clamp head 212 along the post body 214, the tongue 246 can be incrementally positioned such that the locking teeth 248 engage the shaft teeth 270, thus preventing movement of the tongue 246 with respect to the post body 214. The lever 262 is held in the locked position by a releasable arm latch 260. This latch 260 is a flexible tab with a downwardly protruding lip that captures the top edge of the lever 262 and prevents it from unlocking until an upward force is applied to the latch 260 to cause it to flex out of the way, thus allowing the lever 262 to swing into the unlocked position. FIG. 13 shows a perspective of a system where the clamp head 214 is held in the locked position.

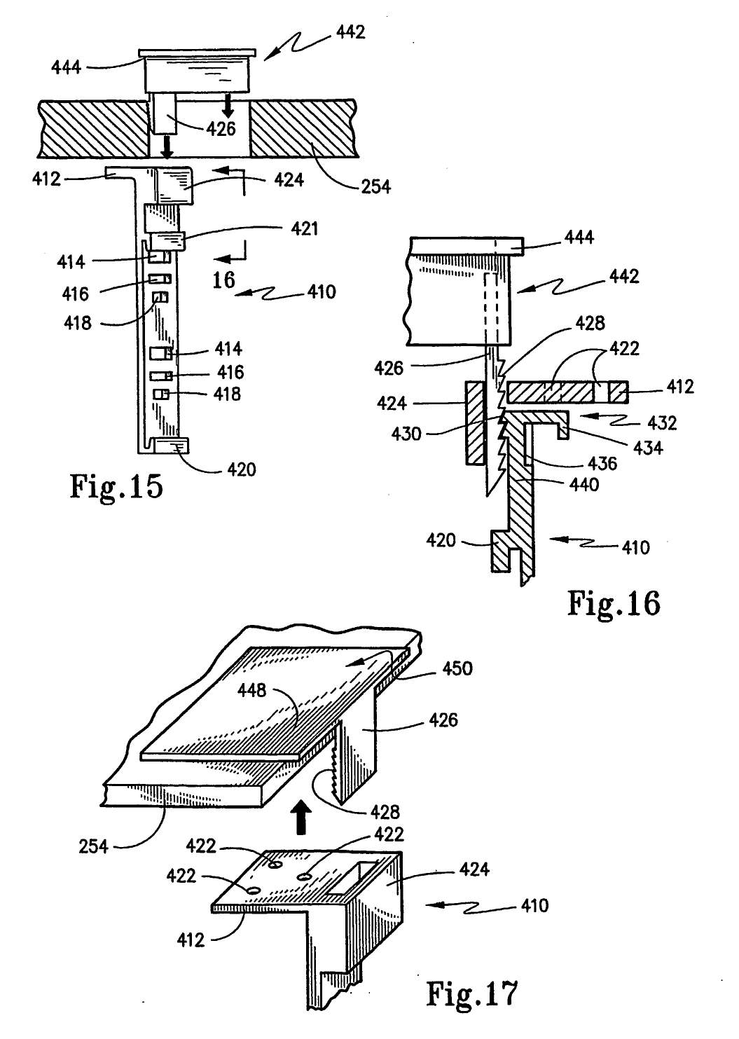

A second embodiment of a post structure for attachment to desks or other flat surfaces is shown in FIGS. 15 through 17. FIG. 15 is a perspective view of the alternate post embodiment 410 and mounting grommet 442 and indicates how the grommet 442 and post 410 connect through the desk top 254. Referring to FIG. 15, the post 410 is formed of a piece which extends downwardly, at its proximal end, from the desk top 254 to its distal end which is formed into a “J”-shaped lower end 420 which receives and supports the lower edge of a panel 18 or slatwall 310 (in the same manner that panel mount flanges 230 on post body 214 in the first embodiment do) in cooperation with opposed upper flange 42. The proximal end of the post 410 has a mounting flange 412 attached, at a generally perpendicular angle, to it. This mounting flange 412 contains attachment holes 422 to facilitate its connection to the desk top 254 via conventional nails, screws, or bolts. When in the mounted state, the mounting flange 412 is flush with the undersurface of desk top 254 and acts to provide resistance to the rotation of the post 410 caused by loads on the attached brackets 12. The post 410 has an upper end 446 located near its proximal end and positioned on the same side of post 410 as the lower end 420. This upper end portion 446 is sized and positioned such that it engages the edge opposite of panel 18 or slatwall 310 that engages the lower end 420. Similar to the first post embodiment already discussed, the panel or slatwall is mounted onto the post 410 by aligning their upper and lower edges with the channels formed by the upper and lower end portions (446 and 420, respectively) and then sliding the panel 12 or slatwall 310 into position.

The post 410 may have one or more groups of rectangular openings (414, 416 and 418) that receive bracket 12 for its attachment directly to the post 410 similar to the means, already discussed, by which the first post embodiment receives a bracket 12. FIG. 15, an oblique side view of a post 410 and grommet 442, shows these openings 414, 416, and 418. The openings 414, 416, and 418 are located on the post 410 in positions such that the brackets 12 may be attached to either side of the post 410 whenever a panel 12 or slatwall 310 is not also attached, thus blocking that side from accepting a bracket 12.

As previously mentioned, the post 410 can be attached to the desk top 254 with conventional fasteners using the attachment holes 422. Another means of mounting the post 410 to a desk top 254 is via a modified grommet 442 which, as shown in FIG. 15, may be inserted into a typical opening in the desk and the post 410 is releasably connected to the grommet 442. The grommet 442 is a hollow cylindrical sleeve with an upper rim 444 which extends radially outward to form a shoulder whose outer diameter is sized to be larger than the diameter of the opening in the desk top. In this manner, the loads on the grommet 442 from the post 410 are born by the desk top through the upper rim 444. Both of the outer diameters of the grommet 442 and the upper rim 444 are sized to mate with standard openings in desks or tabletops. It should be appreciated, however, that the grommet may be of another geometry required to properly mate with tabletop openings other than circular ones.

The attachment of the grommet 442 to the post 410 is accomplished by way of a toothed tongue 426 which is affixed to the sidewall of the inner opening of the grommet 442 and which extends downwardly through the tabletop when the grommet is in the attached position. FIG. 16 shows a side view portion of the grommet 442 along with a sectional view of the upper portion of the post 410. The toothed tongue 426 is formed of an array of teeth 428 which are outwardly facing and downwardly sloping, ramped edges that releasably engage the post 410. This toothed tongue 426 is of sufficient length to facilitate the connection of the post 410 with grommet 442 through desks 254 of various thicknesses.

Referring to FIG. 16, which shows a sectional side view of the proximal end of post 410 along with a side view of a portion of the grommet 442, it is seen that the proximal end of post 410 has an affixed back panel 424. This back panel 424 is an elongated “U”-shaped piece, affixed to post 410, and which forms a generally rectangular opening, along the axis of post 410, for receiving the toothed tongue 426 of grommet 442. The face of post 410 which opposes the back panel 424 has a generally rectangular opening, post opening 436, within which is situated a catch 432.

The catch 432 is formed of a live hinge 440, with locking teeth 430, and a release lever 434. The catch 432 is affixed at its proximal end to the lower edge of the post opening 436 and it extends upwardly and outwardly from that edge. The distal end of catch 432 is formed into an “L”-shaped section, release lever 434, which extends outwardly from the post 410. The uppermost portion of the inward surface of catch 432 has one or more rows of locking teeth 430 formed into it. These locking teeth 430 are upwardly sloping, ramped surfaces, which extend into the cavity formed by back panel 424 and which are sized to mate with the teeth 428 of grommet 442 and provide resistance to the separation of the grommet 442 from the post 410 when the two are connected. The live hinge 440 portion of catch 432 is formed of a sufficiently thin and stiff, but resilient, material such that it can flex during insertion and removal of the toothed tongue 426. The release lever 434, an “L”-shaped element on the upper end of catch 432, is sized to allow a digit of a hand to be inserted into the lower opening formed by it for the purpose of forwardly flexing the catch 432, by virtue of the resiliency of the live hinge 440, and thus disengaging the locking teeth 430 from the teeth 428 of the grommet 442. It is in this manner that the grommet 442 can be released and removed from the post 410. For the engagement of the toothed tongue 426 into post 410 the catch 432 also flexes as result of the teeth 428 of the toothed tongue 426 pushing against the locking teeth 430 as they move past one another during the engagement insertion. The resiliency of the live hinge 440 forces the teeth 428 to mate with the locking teeth 430 when a suitable insertion position is attained. It should be appreciated that one skilled in the art can conceive of other means for releasably engaging the grommet 442 to the post 410.

Another means of attaching a post to a desk 254 is illustrated in FIG. 17 where the post is clamped to the edge of a desk top, table top or other flat horizontal surface. This is accomplished by way of a plate 450 which releasably engages the post 410 to clamp the two parts to the desk 254. The plate 450 includes a clamp piece 448 to which is affixed a toothed tongue 426 with teeth 428. The engagement of the toothed tongue 426 and post 410 is identical to that previously described for the engagement of the grommet 442 and post 410. In the engaged position, the clamp piece 448 and the mounting flange 412 provide a compressive force to the desk 254 in order to hold the post 410 in place. The clamp piece 448 is sized to be able to supply adequate contact surface with the desk surface to be able to sustain the loads on the post 410.

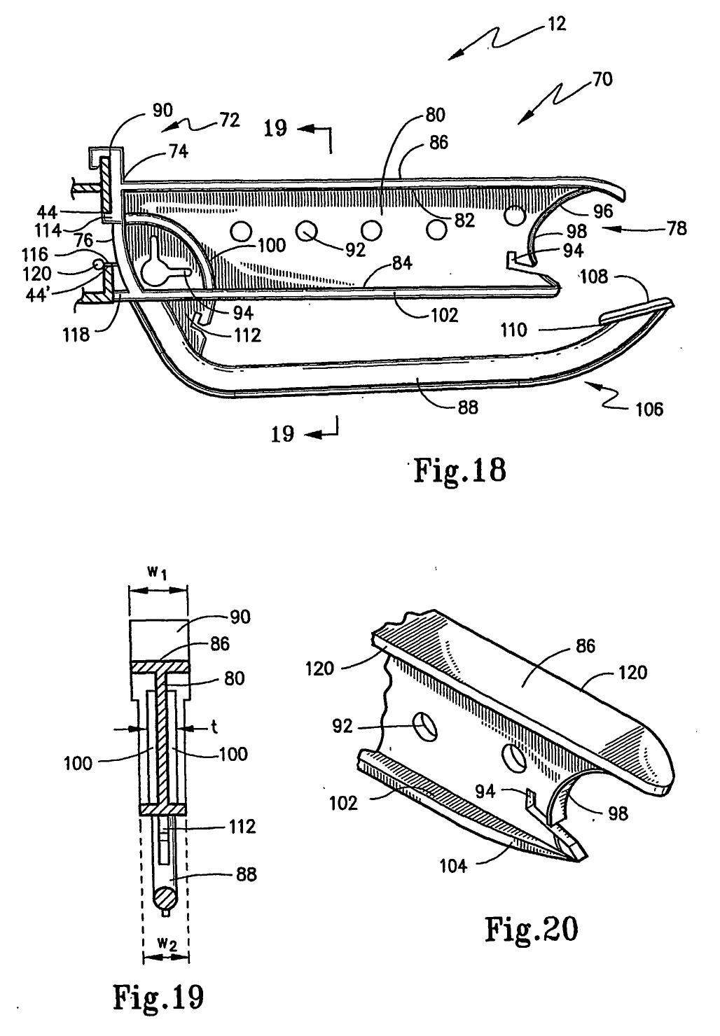

A first embodiment of mounting bracket 12 is shown in FIGS. 18 through 20. The bracket 12 consists of an elongate beam 70 with a free beam end 78, a base 72 with a front base portion 74 and a back base portion 76, and an elongated arm 88. Looking at FIG. 18 (which shows a side view of a bracket 12 and a partial section of an attached panel 18, slatwall 310, or post 210), the base portion 72 includes an upper J-shaped mount 90, a lower tab 114, a locking tongue 116, and a stem 118. The lower tab 114, locking tongue 116, and stem 118 are affixed to the back base 76 of the base portion 72. Using the structure of panel 18 for the sake of explanation, then, the J-shaped mount 90 is sized to capture the upper edge 42 (see FIG. 5 or 12) of an upright member of a panel 18 when in the attached state. Likewise, the lower tab 114 is sized and positioned to engage the corresponding upper center edge 44. Also, when in the attached state, the locking tongue 116 engages the lower center edge 44′ of the center opening 38. The locking tongue 116 is made of an elastically resilient material and has a flared end 120 which moves over the aforementioned lower edge 44′ and locks behind it to secure the bracket 12 from becoming inadvertently dislodged. Stem 118 is a protruding tab which is positioned to rest against a panel or post wall surface and to distribute the compressive thrust load of the bracket forces to the supporting panel 12, slatwall 310, or post 210.

Again referring to FIG. 18, extending away from the front base 74 of the base portion 72 is the elongated beam 70 which includes a vertically oriented planar web 80 with an upper edge 82 and a lower edge 84. As seen in FIG. 19 (a sectional view of FIG. 18) this web 80 has a thickness, t. The upper web edge 82 has a first flange 86 affixed to it with a width, w₁ (see FIG. 19). This flange 86 provides flexural stiffness to the elongated beam portion 70 and also serves as a shelf surface for supporting hardware devices. FIGS. 1 and 2 best show this feature. The lower web edge 84 also has a second flange 102 affixed to it, its primary purpose being to also provide stiffness to the beam portion 70. This second flange 102 does not extend forwardly as far as does the first flange 86. As noted in FIG. 19, the second flange 102 has a width, w₂. This width w₂ is such that it is less than the first flange width, w₁, but greater than the planar web thickness, t. The planar web 80 also has an arcuate rearward reinforcement rib 100 which extends from the base portion 0.72 to the second flange 102 and which provides further stiffening reinforcement to the beam portion 70. As seen in FIG. 20, a partial perspective of the free end 78, the first flange 86 has edges 120 which converge together at the forward end of the beam portion 70. Likewise, the second flange 102 has edges, such as edge 104, which also converge together at this forward end.

Returning to FIG. 18, the free beam end 78 has an arcuate forward edge 96 with a forward reinforcement rib 98. The inwardly-curved shape of the free beam end 78 provides adequate clearance for inserting cables and cable support connectors onto the elongated arm 88. The planar web 80 contains numerous holes 92 and slots 94. The holes are sized for use with commercially available cable connectors such as those shown in FIGS. 26 and 27. The slots 94 are sized to function as pinch-type connection locations for elastic cables 20. FIG. 1 shows examples of this. The forward edge 96 contains one such slot opening 94.

Again referring to FIG. 18, the bracket 12 includes an elongated arm 88, acting as a hook structure, which lies in the plane defined by the planar web 80 and which extends forwardly from the base portion 72 to terminate in an arcuate free arm end 106 and which extends beyond the free beam end 78. In this manner a gap between the planar web 80 and the arm 88 is defined. The cross-sectional shape of this arm 88 is circular but other shapes could be used. A gusset 112 extends between the beam portion 70 and the arm 88 and acts to add flexural stiffness and reinforcement to the arm 88. This gusset 112 may also have a slot 94 formed within it. The elongated arm 88 extends forwardly from the base portion 72 and terminates in a pad 168. This pad 108 is generally oval shaped and is sized such that it creates a rearwardly extending lip 110. This lip 110 serves to act as a catch to prevent suspended cables and cable hangers from inadvertently sliding off of the arm 88.

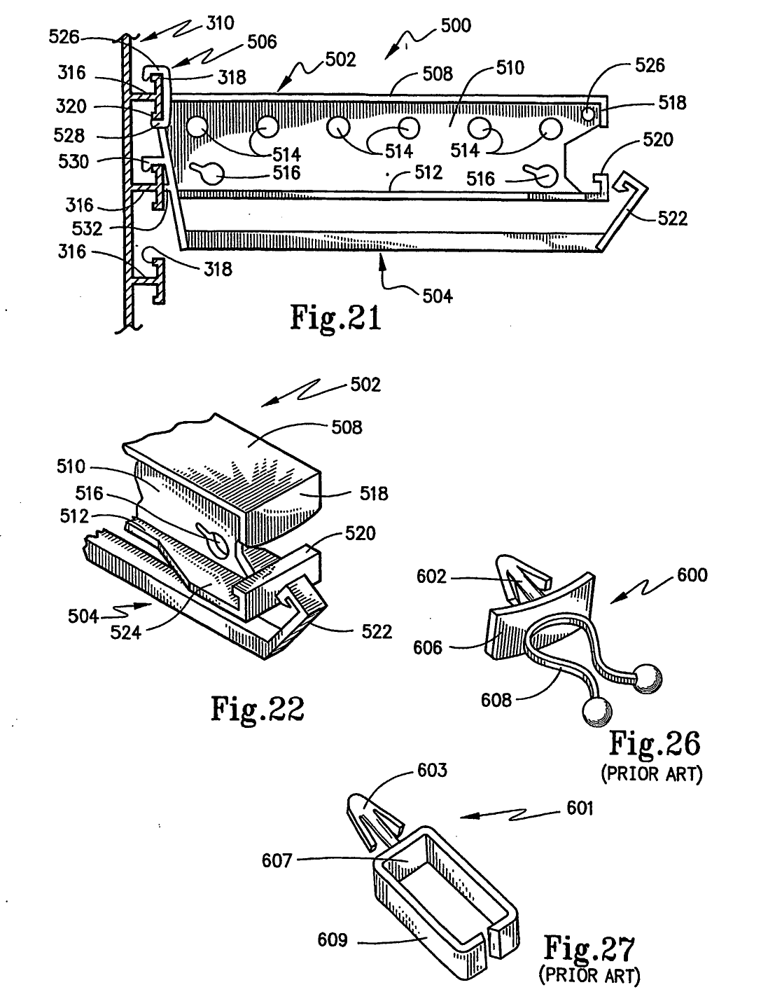

Another embodiment of a bracket 500 is shown in FIGS. 21 and 22. FIG. 21 shows a side view in elevation of a bracket 500 attached, as an example, to a slatwall 310. As seen in this figure, the bracket 500 is formed of a bracket beam 502, a cable rod 504, and a base member 506. The bracket beam 502 is rigidly attached to the base member 506 in such a manner that when the bracket 500 is attached to a panel 18, slatwall 310, or post 210, it extends outwardly and is generally perpendicular to them. The bracket beam 502 comprises a first flange 508, a web piece 510, and a second flange 512 to form an “I” beam type of support member.

The web piece 510 is an upright panel which is rigidly affixed to the first flange 508, the second flange 512 and the base member 506. The web piece 510 may contain a variety of mounting holes 514 which are sized and located to provide connection locations for the attachment of commercially available cable clips and connectors such as those shown in FIGS. 26 and 27. The web piece 510 may also contain slotted holes 516 which are specifically shaped to provide pinch-connectors for commercially available elastic cords 20. The web piece 510 can further have a rod hole 526 to mount a rod (not shown) that can extend between a pair adjacent brackets 500. It may be appreciated that support rods, if desired, could be mounted by any of holes 514, as well. In any event, the support rods can be employed to hold a flexible concealment skirt as a panel to aesthetically hide the wiring components or, if desired, several support rods can be employed to create a shelf-like support structure.

Referring again to FIG. 21, the first flange 508 is an outwardly extending panel element which is affixed to the upper edge of the web piece 510 and which provides both stiffness to the bracket 500 and a support shelf for hardware devices 14 which may be placed on its upper surface (similar to that shown for the first bracket embodiment in FIG. 1). The bottom flange 512 is also an outwardly extending panel element which provides stiffness to the bracket. The distance between the first flange 508 and second flange 512 is sized such that their axes are coincident with the axes of the two corresponding ribs 316, as shown in FIG. 21. The first flange 508 is affixed at its proximal end to the base member 506 and, at its distal end, the first flange 508 is formed into an end portion 518 which extends downwardly from the first flange 508 at a generally right angle. End portion 518 can be used to receive a label or, alternatively, could be used with hook and loop fasteners, for example, as a mounting location for a concealment skirt.

FIG. 22 shows a perspective view in elevation of the distal end of the bracket 500, which is opposite the base member 506. The second flange 512 has edge surfaces which are parallel at the proximal end of bracket 500 and are parallel for a majority of the length of bracket 500, and which outwardly diverge, at the distal end, to form a wide end portion 524. This distal end of the wide end portion 524 is formed into a catch 520 which provides a releasable latch structure for supporting the cable rod 504 when it is in the latched position.

As seen in FIG. 21, a cable rod 504 is attached at its proximal end to the base member 506 such that, when the bracket 500 is in the mounted state, the cable rod 504 extends outwardly from the slatwall 310 in a generally perpendicular direction. The cable rod 504 provides a hanger rod for cable sets 16 and is of a rectangular cross-section but other cross-sectional shapes could also be employed. Referring to FIG. 22, a latch arm structure 522 is affixed to the distal end of the cable rod 504 and serves to engage and capture the catch 520 for releasably latching the cable rod 504 relative to the bracket beam 502 once cables sets 16 have been placed onto the cable rod 504. The latch arm structure 522 extends outwardly from cable rod 504 at an obtuse angle to it. The distal end of latch arm structure 522 turns back onto itself at generally right angles to create a channel which mates with the catch 520 of the bracket beam 502. The latching is accomplished by pushing the latch arm structure 522 towards the latch piece 520 which causes the latch arm structure 522 to firstly ride over the top edge of catch 520 and secondly to capture the latch piece 520. Unlatching is accomplished by flexing the cable rod 504, transversely to the bracket 500, until the latch arm structure 522 moves beyond the outer edge of catch 520 and thus disengages from the latch piece 520. The cable rod 504 and latch arm structure 522 are made of a stiff but resilient material such that the mating of the latch arm structure 522 to the catch 520 is accomplished by flexure of the two pieces. A person skilled in the art can envision other geometries possible for the latch piece 520 and latch arm structure 522 that will accomplish the same function as what is described here.

Referring again to FIG. 21, the base member 506 is made up of an upper J-shaped mount 526, a lower tab 528, a locking tab 530 and a stem 532. These elements are similar in function and purpose to those discussed for the first bracket 12 embodiment (illustrated in FIG. 18). The lower tab 528, locking tongue 530, and stem 532 are affixed to the base member 506. The J-shaped mount 526 is sized to capture the upper edge 318 (or an edge 42 of a panel 18) when in the attached state. Likewise, the lower tab 528 is sized and positioned to engage the corresponding center edge 320 (or an edge 44 of panel 18). Also, when in the attached state, the locking tab 530 engages the next adjacent lower center edge 318 (or the lower center edge 44′ of the center opening 38 of panel 18). The locking tab 530 is made of an elastically resilient material and has a flared end which moves over the aforementioned edges and locks behind it to secure the bracket 12 from becoming inadvertently dislodged. Stem 532 is a protruding tab which is positioned to rest against a panel or post wall surface and to distribute the compressive thrust load of the bracket forces to the supporting panel 12, slatwall 310, or post 210.

Cables can be attached to the systems discussed by suspending looped cables from the bracket arms 88 or 504 or by connecting them to commercially available connectors 600 or 601, examples of which are shown in FIGS. 26 and 27. These connectors are mounted onto the brackets 12, 500 or the panels 18 by way of the provided holes 52, 92 or 514. These types of connectors generally consist of a flexible, barbed wing plug 602 or 603, a back panel 606 or 607 and a flexible cable-capturing structure 608 or 609. The wing plugs 602,603 each has two or more flexible tabs which can bend toward the plug to allow forced insertion into a hole but, once inserted, they flex outwardly to a size bigger than the hole's diameter to lock the connector in place by virtue of the clamping action on the surface with the contact of the back panel 606,607 on the opposite side of the mounting surface. The capturing structure 608,609 is of a resilient material that can be flexed or shaped such that it holds one or more cables.

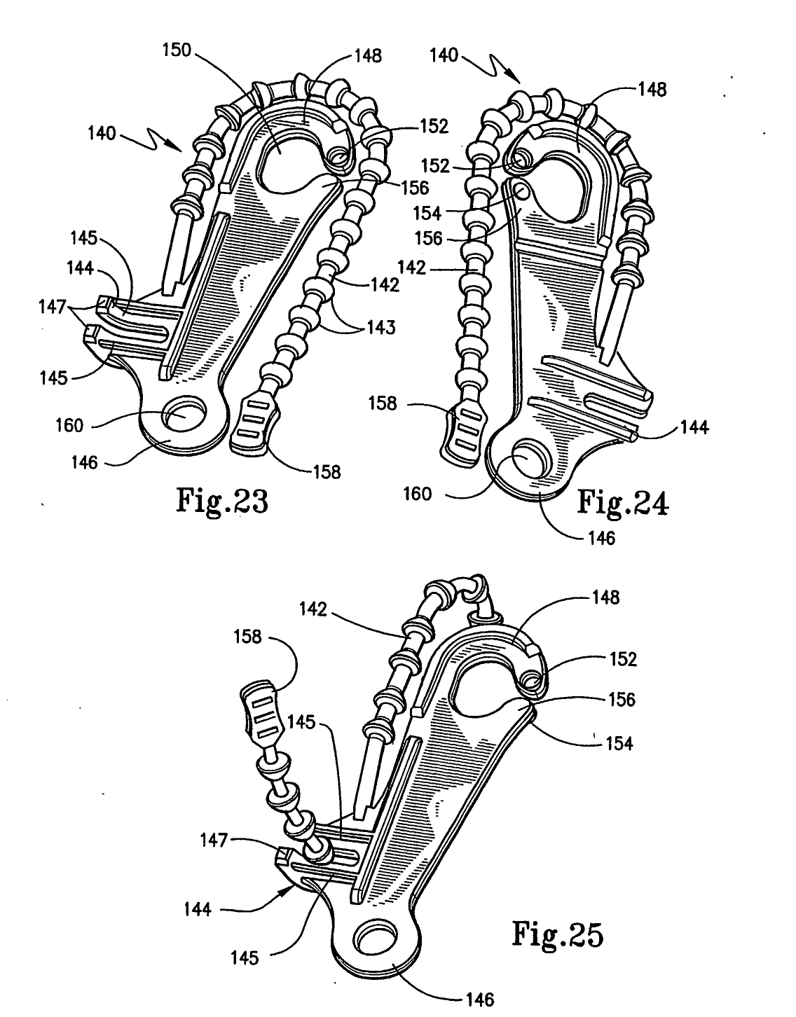

Cables can also be suspended by means of a cable hanger 140 (shown in FIGS. 23 through 25 and shown in use in FIG. 1). The cable hanger 140 is a flat, elongated structure formed with an tab 146 at one end and a J-shaped structure 148 and finger 156 opposing structure 148. The J-shaped structure 148 curves toward the finger 156 to create a connection opening 150 with a gap between the structure 148 and the finger 156. The end of the structure 148 nearest the finger 156 contains a hole 152 within which a plug 154, situated on one side of the finger 156, fits. The cable hanger 140 is made of an elastic material with sufficient flexibility such that the J-shaped structure 148 and the finger 156 can be manually flexed to insert the plug 154 into hole 152. FIG. 1 shows an example of this where the cable hanger 140 has been mounted onto the arm 88 of a bracket 12 and then locked closed in order to hold it onto the arm 88.

The cable hangers also have a ribbed tail 142, made of a flexible material, a tail lock tab 144 and a tail tab 146. As shown in FIG. 1, cables are suspended from the cable hanger 140 by feeding the ribbed tail through one or more cable loops and then locking the tail 142 into the lock tab 144. This is facilitated by the tab 146 and the tail tab 158 which can be grasped between a thumb and forefinger for this operation. FIG. 25 shows the cable hanger 140 with the tail 142 locked in this position. The multitude of ribs or stops 143 along the tail 142 allows one to selectively engage it into the tab 146 depending on the size and numbers of the cables supported by this. To this end, also, lock tab 144 includes a pair of spaced tines 145 having upturned ends 147. This configuration helps secure the stops 143 against inadvertent disengagement.

One skilled in the art can appreciate that the various system components thus mentioned can be made from a variety of materials with the specific sizing and geometry of their features chosen to provide the necessary stiffness and strength for the proper function. While preferred materials for the cable hangers 140 are low density polyethylenes (LDPE) and the preferred materials for the brackets, posts, slatwalls and panels are glass-filled nylons, other types of materials would be suitable as well. The components of these structures can be integral one piece injection moldings.

The embodiments described in this section define a user configurable system for storing and organizing cables and electronic equipment that can be easily adapted to a particular need as well as reconfigured when changes are desired. FIG. 1 shows an example of how equipment and cabling can be supported or attached (FIG. 2 shows the same system but without the cables and electronic equipment). In this figure, a pair of brackets 12 have been mounted and spaced such that their upper edges create a shelf for a hard drive, router, power supply, etc. These pieces can be secured by elastic cords 20 which are attached to the brackets 12 by means of provided pinch slots. Arms 88 provided on the brackets 12 can be used for supporting cable hangers 140 or for directly looping cables over. As shown by the examples in FIGS. 1, 3, 13, and 28, the system can be configured in numerous ways. The brackets 12 can be supported by a post 230 which is clamped or attached to a desk or shelf. Alternately, the post 230 can support panels 18 or slatwalls 310 which, in turn, support brackets 12. These panels 18 or slatwalls 310 can also be directly attached to a vertical surface in lieu of the post 24.

The present invention is also directed to a method for organizing and storing electronic equipment and cabling comprising the steps inherent in the above-described structure. More particularly, the method includes a step of releasably attaching at least one support member to a support surface such that a support member is oriented in an upright state. The method also includes the step of selectively arranging a plurality of mounting brackets onto the mounting member in a manner to create an array defining a stable, generally horizontal support surface for equipment. The method then includes the step of releasably locking the mounting brackets to the support member. Finally, the method includes placing electronic equipment on the mounting brackets and securing electric cables by suspending them from the mounting brackets.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

1. A mounting bracket adapted to secure to an upright support member when in a secured state, comprising:
(A) a base having a front and a back and operative to engage an upright support member in the secured state;
(B) an elongate beam portion extending forwardly of said base to terminate in a free beam end, said beam portion including;
(1) a planar web oriented in a web plane and having a selected web length between said base portion and said free beam end, a selected web height between an upper and a lower edge thereof and a selected web thickness and
(2) a first flange oriented transversely of said web and having a first flange width greater than the web thickness but less than the web height; and
(C) a hook structure extending forwardly of said base and supported thereby.

2. A mounting bracket according to claim 1 wherein said base includes a J-shaped mounting portion disposed thereon.

3. A mounting bracket according to claim 1 wherein said base includes a latch structure formed thereon.

4. A mounting bracket according to claim 1 wherein said planar web includes at least one opening formed therein.

5. A mounting bracket according to claim 4 wherein said planar web includes a plurality of openings formed therein.

6. A mounting bracket according to claim 5 wherein at least one opening is formed as a slot.

7. A mounting bracket according to claim 4 wherein said planar web includes a forward edge with said opening formed as a slot intersecting said forward edge.

8. A mounting bracket according to claim 1 wherein said planar web includes a forward edge and a forward reinforcement rib proximate to said forward edge.

9. A mounting bracket according to claim 1 wherein said planar web includes a rearward reinforcement rib proximate to said base portion.

10. A mounting bracket according to claim 1 wherein said first flange is located on the upper edge of said planar web and extends forwardly for a first flange length and wherein said elongate beam portion includes a second flange disposed on the lower edge of said planar web and extending forwardly for a second flange length.

11. A mounting bracket according to claim 10 wherein said second flange has a second flange width that is less than the first flange width but that is greater than said web thickness.

12. A mounting bracket according to claim 10 wherein the second flange length is less than the length of the first flange length.

13. A mounting bracket according to claim 10 wherein said second flange has forwardly convergent opposite side edges.

14. A mounting bracket according to claim 1 wherein said hook structure is an elongated arm spaced apart from said beam portion and terminating in a free arm end.

15. A mounting bracket according to claim 14 wherein said free arm end extends forwardly of said planar web.

16. A mounting bracket according to claim 14 wherein said elongated arm generally lies within said web plane.

17. A mounting bracket according to claim 14 wherein said free arm end includes a pad.

18. A mounting bracket according to claim 17 wherein said pad includes a rearwardly extending lip.

19. A mounting bracket according to claim 14 wherein said hook structure includes a gusset extending between said elongated arm and beam portion.

20. A mounting bracket according to claim 14 wherein said elongated arm terminates in an arcuate free arm end which curves toward said beam portion to leave a gap between said planar web and free arm end.

21. A mounting bracket adapted to secure to an upright support member when in a secured state, comprising:
(A) a base having a front and a back and operative to engage an upright support member in the secured state;
(B) an elongate beam extending forwardly of said base to terminate in a free beam end and including
(1) a planar web oriented in a web plane and having a selected web length between said base and said free beam end, a selected web height between an upper and a lower edge thereof and a selected web thickness and
(2) an upper flange disposed on said upper edge and oriented transversely of said to define a generally flat shelf surface; and
(C) an elongate support arm extending forwardly of said base generally in the web plane to terminate in a free arm end, said support arm being in a spaced relation to said beam.

22. A mounting bracket according to claim 21 wherein said base includes a J-shaped mounting portion disposed thereon.

23. A mounting bracket according to claim 21 wherein said planar web includes a plurality of openings formed therein.

24. A mounting bracket according to claim 23 wherein at least one of the openings is formed as a slot.

25. A mounting bracket according to claim 21 wherein said planar web includes a forward edge with one of the openings formed as a slot intersecting said forward edge.

26. A mounting bracket according to claim 21 wherein said planar web includes a forward edge and a forward reinforcement rib proximate to said forward edge.

27. A mounting bracket according to claim 21 wherein said planar web includes a rearward reinforcement rib proximate to said base portion.

28. A mounting bracket according to claim 21 wherein said elongate beam portion includes a lower flange disposed on said lower edge of said planar web, said lower flange having a selected lower flange width that is less than the upper flange width but greater than the planar web thickness.

29. A mounting bracket according to claim 21 wherein said free arm end includes a pad, said pad including a rearwardly facing lip.

30. A mounting bracket according to claim 21 wherein said elongate support arm includes a gusset extending between said arm and beam portion.

31. A mounting bracket according to claim 21 wherein a portion of said arm proximate to the free arm end is formed as an arcuately shaped section curving toward said beam portion to leave a gap between said planar web and free arm end.

32. A support system adapted to support electrical components and wires therefor relative to a structure, comprising:
(A) a first upright support member adapted to be secured in a generally vertical orientation relative to a support structure to define a secured state, said first upright support member including at least two support panel sections each having an exposed and free upper edge when in the secured state; and
(B) at least two mounting brackets, each said mounting bracket including
(1) a base having a front and a back and adapted to engage said upper edge of a respective said support panel section in a mounted state whereby at least two said mounting brackets may be simultaneously supported in the mounted state;
(2) a generally rigid, elongate beam extending forwardly of said base, said beam including an upper flat surface that is generally horizontal when said support member is in the secured state and said bracket is in the mounted state and a web portion extending generally perpendicularly to the upper flat surface in a web plane; and
(3) an elongate support arm extending forwardly of said base generally in the web plane to terminate in a free arm end, said support arm being in a spaced relation to said beam.

33. A support system according to claim 32 including a plurality of suspension members adapted to receive and releasably retain wires associated with said electrical components.

34. A support system according to claim 33 wherein said suspension members are defined by a plurality of cable hangers each adapted to engage the support arm of one of said mounting brackets.

35. A support system according to claim 34 wherein said cable hangers each have a flat body with a hook structure adapted to engage the support arm of one of said mounting brackets, a locking tab and an elongated, flexible tail, said tail connected at a proximal end to said flat body and having a free end selective engagable by said locking tab.

36. A support system according to claim 32 wherein said first upright support member has a plurality of slots formed therein, and including at least one elastic cord releasably mountable in said slots.

37. A support system according to claim 32 wherein said mounting brackets each has at least one slot formed therein, and including at least one elastic cord releasably mountable in said slots.

38. A support system according to claim 32 wherein at least one of said brackets and said upright support member has a plurality of holes formed therein and including a cable connector adapted to matably mount in the hole.

39. A support system according to claim 32 including a second upright support member different from said first upright support member, one of said first and second upright support members operative to selectively mount another of said first and second upright support members.

40. A support system adapted to support electrical components and wires therefor, comprising:
(A) a first upright support member including at least two capture flanges;
(B) a second upright support member with two opposing tabs adapted to be secured to said capture flanges and including at least two support panel sections each having an exposed edge;
(C) at least two mounting brackets, each said mounting bracket including
(1) a base adapted to engage said exposed edge of a respective said support panel section in a secured state whereby said mounting brackets may be simultaneously supported in the secured state;
(2) an elongate support arm including a central portion extending forwardly of said base and terminating in a free first arm end;
(3) an elongate beam extending forwardly of said base in space-apart relation to said support arm.

41. A method for organizing and storing electronic equipment and electric cables therefor, comprising:
(A) releasably attaching at least one support member to a support surface such that it is oriented in an upright position;
(B) selectively arranging a plurality of mounting brackets onto the mounting member in a manner to create an array defining a stable, generally horizontal support surface for equipment;
(C) releasably locking said mounting brackets to the support member;
(D) placing electronic equipment on said mounting brackets; and
(E) securing the electric cables by suspending said from the mounting brackets.
